(19) United States
(12) Patent Application Publication
(10) Pub. No.: US 2022/0026615 A1
(43) Pub. Date: Jan. 27, 2022

(54) HIGH-RADIANCE WAVELENGTH-AGILE INCOHERENT LIGHT-SOURCE

(71) Applicant: Coherent, Inc., Santa Clara, CA (US)

(72) Inventors: Sergei V. GOVORKOV, Los Altos, CA (US); John H. JERMAN, Palo Alto, CA (US)

(73) Assignee: Coherent, Inc., Santa Clara, CA (US)

(21) Appl. No.: 17/296,921

(22) PCT Filed: Dec. 10, 2019
(86) PCT No.: PCT/US2019/065518

§ 371 Date: May 25, 2021

Related U.S. Application Data
(60) Provisional application No. 62/779,365, filed on Dec. 13, 2018.

(51) Int. Cl. F21V 8/00

(52) U.S. Cl. CPC G02B 6/0003

(57) ABSTRACT

A source of high-radiance broad-band incoherent light includes an optical waveguide, having a core made of phosphor granules embedded in a matrix of glass and a cladding. The core having a relatively high refractive index and the cladding having a relatively low refractive index. The phosphor granules and the glass matrix having about the same refractive index. Radiation from one or more diode-lasers is injected into one end of the waveguide to energize the phosphor granules, producing broad-band incoherent light, which is confined and guided to an opposite end of the waveguide as output light.

### CROSS REFERENCE TO RELATED APPLICATION

This application claims the benefit of U.S. Patent Application 62/779,365, filed Dec. 13, 2018, which is hereby incorporated by reference in its entirety.

### TECHNICAL FIELD OF THE INVENTION

The present invention relates in general to light-sources for flow cytometry instrumentation. The invention relates in particular to high-radiance light-sources capable of delivering light at a plurality of different wavelengths across the visible portion of the electromagnetic spectrum.

### DISCUSSION OF BACKGROUND ART

One well-known cellular analysis technique is flow cytometry. A basic principle of flow cytometry is the passage of particles in a fluid-stream through a focused beam of laser radiation. The particles, particularly biological cells, can be detected, identified, counted, and sorted. Cell components are fluorescently labelled and then illuminated by the laser radiation. Scattered and emitted radiation can be measured to determine the quantity and types of cells present in a sample.

Several detectors are carefully placed around the point where the fluid-stream passes through the focused laser-beam. The suspended particles, which may range in size from 0.2 micrometers (μm) to 150 μm, pass through the focused laser-beam and scatter the laser radiation. The fluorescently-labelled cell components are also excited by the focused laser-beam and emit radiation (fluorescence) at a longer wavelength than that of the laser-beam. This combination of scattered and fluorescent radiation is measured by the detectors. Measurement data is then analyzed, using special software, by a computer that is attached to the flow cytometer. Thousands of particles per second can be measured and analyzed.

Another well-known cellular analysis technique is high-content cell screening, used in biological research to identify substances such as small molecules that alter a cell in a desired manner. These changes may include increases or decreases in the production of cellular products, such as proteins, or changes in the visual appearance of the cell.

In high-content cell screening, cells are first incubated with the substance and after a period of time structures and molecular components of the cells are analyzed, primarily by automated analysis of an image produced by illuminating the altered cells with a laser-beam having a plurality of different wavelengths. Through the use of fluorescent tags, with different absorption and emission spectra, it is possible to measure several different cell components in parallel.

It is generally accepted that the above-described processes are more flexible and more accurate when the laser-beam includes more wavelengths. In practice, this is accomplished by combining component beams from different lasers along a common path to provide a combined beam that is focused into a sample being analyzed. Diode-laser modules are typically used for providing the component beams. Commercially available diode-laser modules can provide laser radiation at selected fundamental wavelengths in a range from the near ultraviolet to the near infrared.

A laser-source including such a plurality of diode-lasers and associated beam combining optics adds significant cost to apparatus for performing cellular analysis. The more wavelengths that are required, the higher the cost. There will always be “gaps” in the output spectrum of the light-source, as the wavelengths of individual diode-lasers are discrete. Further, the accuracy of the apparatus will be limited by electronic noise in the diode-lasers and interference effects due to coherence of the laser radiation.

There is a need for a light-source having a radiance comparable to the radiance of such multi-wavelength light-sources that does not require a plurality of different diode-lasers and combining optics. Such a source preferably emits incoherent radiation with a relatively continuous output spectrum.

### SUMMARY OF THE INVENTION

In one aspect of the present invention, an optical waveguide comprises a core and a cladding. The core includes phosphor granules in a glass matrix, which has a relatively high refractive index. The phosphor granules and the glass matrix have about the same refractive index. The cladding has a relatively low refractive index.

In another aspect of the present invention, optical apparatus comprises an optical waveguide having a core and a cladding. The core includes phosphor granules in a glass matrix having a relatively high refractive index. The phosphor granules and the glass matrix of the core have about the same refractive index. The cladding has a relatively low refractive index. The optical apparatus further includes a pump-radiation source arranged to direct pump-radiation into a proximal end of the optical waveguide. The pump-radiation propagates along the waveguide. The pump-radiation causes the phosphor granules to emit broad-band incoherent radiation. A portion of the broad-band incoherent radiation is guided by the waveguide to a distal end of the optical waveguide.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a cross-sectional view schematically illustrating a portion of one preferred embodiment of optical fiber waveguide in accordance with the present invention, the fiber waveguide having a core made of phosphor granules in a glass matrix, with the phosphor granules and the glass matrix having about the same relatively-high refractive index, and the core surrounded by a cladding having a relatively-low refractive index.

FIG. 2 is a cross-sectional view schematically illustrating a preferred optical arrangement in accordance with the present invention, including the fiber waveguide of FIG. 1, a dichroic coating on an entrance-facet of the fiber waveguide, and a hemispherical end-cap attached to an exit-facet of the fiber waveguide, the optical arrangement overlaid with simulated rays of broad-band radiation emitted by the phosphor granules in the core of the fiber waveguide.

FIG. 3 is a cross-sectional view schematically illustrating another preferred optical arrangement in accordance with the present invention, including the optical arrangement of FIG. 2 and an aspheric positive lens, the lens arranged to collect and collimate broad-band radiation guided in the fiber waveguide to the exit-facet and emerging through the end-cap.

FIG. 4 is a graph schematically illustrating refractive index as a function of wavelength for two commercially-available high refractive-index glasses and three rare-earth crystalline phosphors.

FIG. 5 is a side view schematically illustrating a preferred embodiment of high-radiance wavelength-agile incoherent light-source in accordance with the present invention, including the optical arrangement of FIG. 3, a pump-radiation source, focusing optics, and beam processing optics, the focusing optics directing pump-radiation into the core of the fiber waveguide, the beam processing optics for beam shaping and spectral section of the collimated broad-band radiation.

FIG. 6 is a perspective view schematically illustrating a preferred embodiment of optical planar waveguide in accordance with the present invention, with pump-radiation directed into one end of the planar waveguide, and broad-band radiation emerging through an ellipsoidal end-cap at an opposite end of the planar waveguide.

FIG. 7A, FIG. 7B, and FIG. 7C are end views schematically illustrating steps in one preferred construction of phosphor-containing planar waveguide in accordance with the present invention.

FIG. 8A, FIG. 8B, and FIG. 8C are end views schematically illustrating steps in another preferred construction of phosphor-containing planar waveguide in accordance with the present invention.

### DETAILED DESCRIPTION OF THE INVENTION

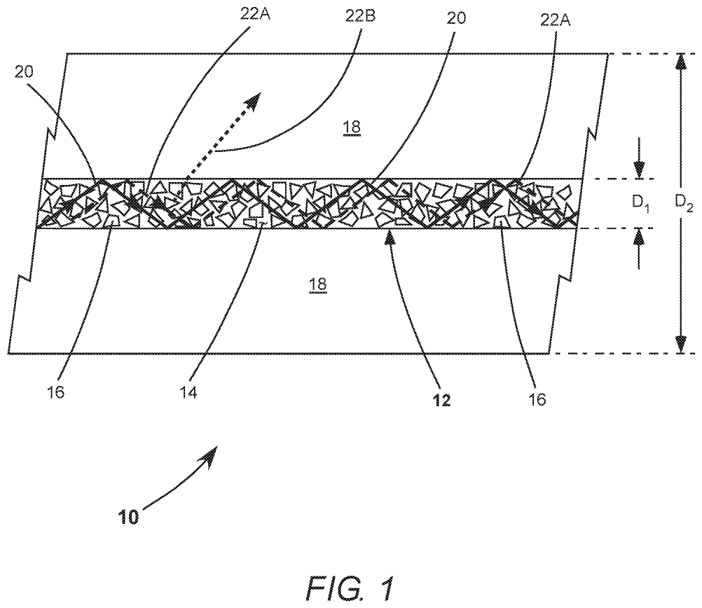

Turning now to the drawings, wherein like features are designated by like reference numerals, FIG. 1 schematically illustrates in cross-section a portion of one preferred embodiment of an optical fiber waveguide 10 in accordance with the present invention. Fiber waveguide 10 includes a core 12 made of a glass matrix 14 containing granules 16 of one or more rare-earth crystalline phosphors. The phosphor granules have rare-earth ions doped into a crystalline host material. Such phosphor granules are commercially available, for example, from PhosphorTech Corporation of Kennesaw, Ga.

The crystalline host material typically has a refractive index between about 1.7 and about 2.0, depending on the material and dispersion characteristics of that material. Glass matrix 14 should have a refractive index which at least approximately matches that of the phosphor granules, recognizing that an exact match is not possible over a wide wavelength range due, inter alia, to different phosphor granules having slightly different refractive indices and dispersion characteristics different from those of the glass matrix. The glass matrix should have a softening point significantly lower than that of the phosphor granules. Cladding 18 preferably has a refractive index of less than about 1.6 to provide that fiber waveguide 10 has a relatively high numerical aperture (NA). The cladding should also have a softening point significantly lower than that of the phosphor granules. However, the cladding preferably has a softening temperature greater than that of the glass matrix in order to facilitate fiber drawing.

Regarding physical dimensions, core 12 preferably has a diameter D₁ between about 10 micrometers (μm) and about 500 μm. Cladding 18 preferably has a diameter D₂ between about 100 μm and about 1000 μm. Generally, smaller dimensions are preferred, as larger dimensions lower the output brightness and lead to difficulties with bending the fiber waveguide and heat-removal. Phosphor granules 16 preferably have root-mean-square dimensions of between about 3.0 μm and about 20 μm. A preferred concentration of the phosphor granules in the core is about 10% by weight. Higher concentrations can lead to difficulty in removing waste heat from the core.

Continuing with reference to FIG. 1, the inventive fiber waveguide is optically pumped to energize the rare-earth ions in the phosphor granules of the core. Broad-band incoherent radiation (phosphorescence) is generated by interaction of radiation from one or more diode-lasers (not shown in FIG. 1) with the phosphor granules. It is desirable to confine emitted broad-band radiation as much as possible within the core to maximize the radiance of the broad-band radiation that emerges through an exit-end of the fiber waveguide (not shown). Diode-laser radiation 20 propagates in core 12 in a highest-order mode as indicated by solid bold line. A dashed bold line indicates one ray 22A of broad-band radiation propagating within core 12 in the same direction as diode-laser radiation 20, confined according to the NA of the fiber waveguide.

In practice, the broad-band radiation is not only emitted from the phosphor granules within the NA of fiber waveguide 10, but in all directions. A dotted bold line indicates one ray 22B of broad-band radiation that is emitted at an angle outside the NA, which then escapes from the fiber waveguide. The higher the NA of the fiber waveguide, the higher the fraction of the generated broad-band radiation that is confined within the core. Broad-band radiation is not only emitted in the propagation direction of the diode-laser radiation, but also in the reverse direction. Broad-band radiation that is emitted in the reverse direction and is confined within the core can be redirected by a dichroic mirror coated on an entrance-end of the fiber waveguide (not shown) through which the diode-laser radiation is injected. This is discussed further hereinbelow.

By way of example, a fiber waveguide in accordance with the present invention has a core refractive index of 1.83 and a fused silica glass cladding having a refractive index of 1.45. The fiber waveguide will have an internal NA of about 0.62, which corresponds to an internal incidence angle on the core-cladding interface of about 52°. About 21% of the total broad-band radiation emitted by the phosphor granules in the core can be confined in the fiber waveguide. For comparison, a fiber waveguide having soda-lime glass cladding with a refractive index of 1.52, would have an internal NA of about 0.56 and a corresponding internal incidence angle of about 56°. About 17% of the total broad-band radiation emitted by the phosphor granules in the core can be confined in the fiber waveguide.

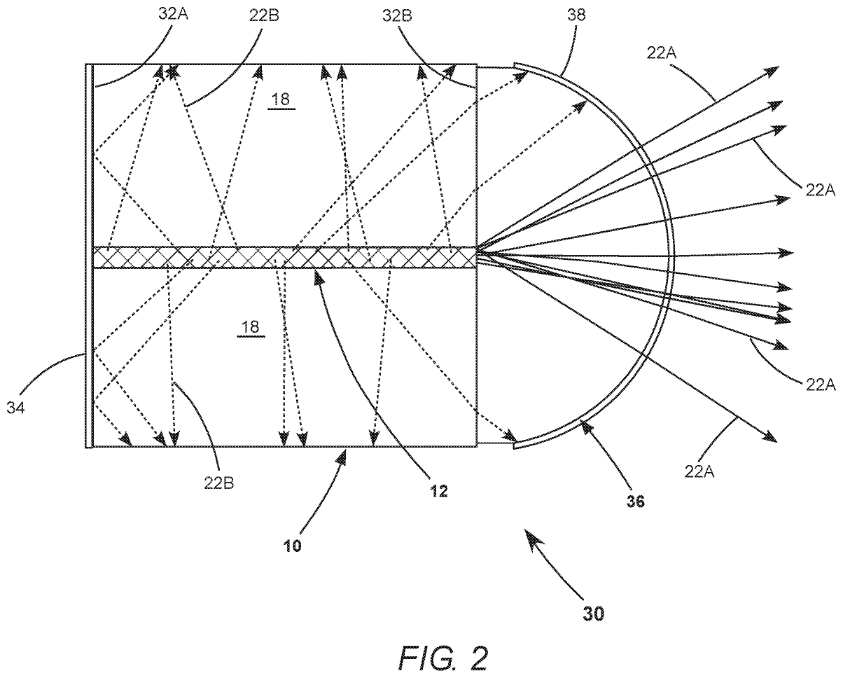

FIG. 2 schematically illustrates an optical arrangement 30 in accordance with the present invention, including fiber waveguide 10 of FIG. 1, which has an entrance-facet 32A through which diode-laser radiation (not shown) is injected and an exit-facet 32B through which broad-band output radiation emerges. A dichroic coating 34 is provided on entrance-facet 32A. Coating 34 is transparent at the wavelength of the diode-laser radiation and reflective for the broad-band radiation generated by the phosphor granules. A hemispherical end-cap 36 is attached to exit-facet 32B having a convex spherical exit-surface. End-cap 36 has the same refractive index as core 12, which enables broad-band radiation to emerge from the core with minimal reflection loss. Total internal reflection would otherwise limit broad-band radiation emerging from exit-facet 32B to a relatively small internal NA, due to the relatively high refractive index of the core. Reflection losses may be further mitigated by providing an antireflection coating 38 on the exit-surface of the end-cap.

Overlaid onto FIG. 2 are simulated rays of broad-band radiation emitted by the phosphor granules, obtained by ray-trace modeling. Rays 22B (dotted lines) emitted at angles greater than the NA of the core eventually leave the fiber waveguide in random directions and are not useful radiation. Rays 22A (solid lines), which are confined within the NA of the fiber waveguide, will emerge through end-cap 36 radially at all angles within the NA of the fiber waveguide. If the center of curvature of the convex spherical exit-surface is located near the core and close to exit-facet 32B, the internal NA and external NA will be about the same.

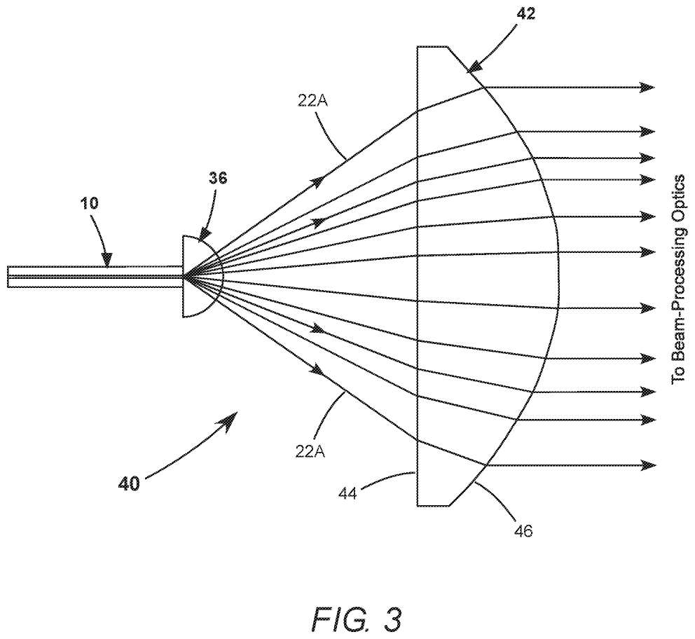

FIG. 3 schematically illustrates another optical arrangement 40 in accordance with the present invention, wherein the broad-band radiation emerging from end-cap 36 is collected by an aspheric lens 42. Lens 42 has a planar entrance-surface 44 and a convex aspheric exit-surface 46. Rays 22A that are transmitted through end-cap 36 are collected and collimated by lens 42. A suitable aspheric focusing lens is Part Number A45-32HPX.1 available from Asphericon GmbH of Jena, Germany. In the drawing, hemispherical end-cap 36 has a much larger diameter than fiber waveguide 10. A minimum requirement is that the end-cap has a larger diameter than the core of fiber waveguide 10, but a larger end-cap is usually more practical

The collimated rays can be directed into beam-shaping or focusing optics, dependent on a particular application, optionally with spectral-selection optics such as dichroic filters or band-pass filters. It should be noted that even though only about 20% of the broad-band radiation emitted by the energized core is available for an application, the brightness of this radiation can still be two or more orders-of-magnitude higher than would be available from broad-band light-emitting diodes (LEDs).

As discussed above, it is important that the phosphor granules and the glass matrix in the core have refractive indices that match as closely as possible over the range of wavelengths emitted by the phosphor granules. This refractive-index matching avoids excess scattering of the broad-band radiation propagating in the fiber core. It was determined that most useful types of phosphor granules have refractive indices that, over most of the visible spectrum, are between those of high refractive index optical glasses SF6 and SF57. These glasses are commercially available from Schott AG of Mainz, Germany. These glasses are examples of leaded heavy flint glasses with a lead oxide (PbO) content greater than about 60% by weight and up to about 88% by weight. In this type of glass, increased lead content generally results in a higher refractive index. There are also lead-free glasses with similar refractive indices, but with different melting characteristics, which may be suitable for this application.

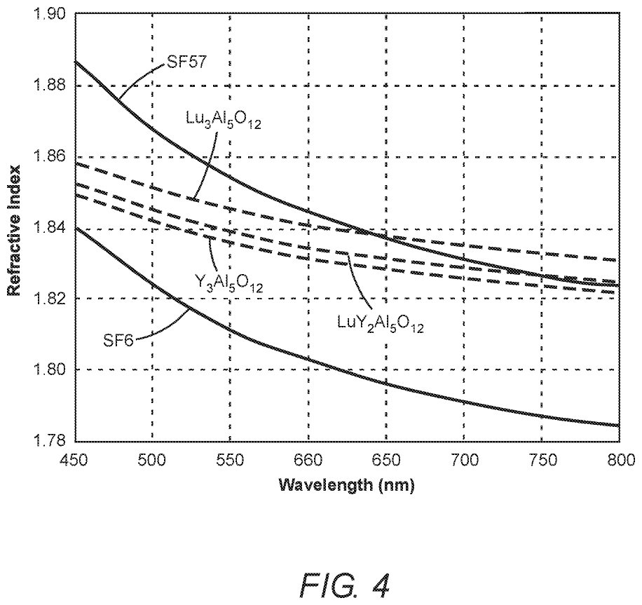

This refractive index matching is depicted in graphically in FIG. 4. By way of example, the dispersion curves of SF57 and SF6 glasses are compared to the dispersion curves of Lu₃Al₅O₁₂, LuY₂Al₅O₁₂, and Y₃A₁₅O₁₂ (garnet) crystalline host materials. The rare-earth ions in a crystalline host material determine the spectrum of radiation emitted by any particular type of phosphor granule, but do not significantly affect the refractive index and dispersion. Glasses having dispersion curves between those of SF6 and SF57 can be made by mixing the two glasses in appropriate proportions to obtain a more precise refractive-index match with any type of phosphor granule.

Clearly, an exact refractive-index match is not possible over the whole emission spectral-range of a phosphor granule. However, given that the greatest refractive index mismatch at any wavelength over the visible spectrum may never be more than about 0.02 and that the phosphor granules are present in the core in a relatively low-weight fraction as discussed above, scattering losses for the broad-band radiation in the core will be relatively low compared to losses due to emission at angles outside the internal NA. There is little to be gained by trying to formulate a specific glass matrix material that exactly matches the index of a particular type of phosphor granule over its entire emission spectral-range.

An experimental fiber preform was fabricated using a tube made of a soda-lime glass having a refractive index of about 1.52 at a wavelength of 570 nanometers (nm) to provide the cladding. A solid rectangular rod was fitted inside the tube to provide the core. The core-rod was made of a mixture of SF6 and SF57 glasses combined with between five and ten weight-percent of Ce³⁺:Y₃Al₅O₁₂ phosphor granules, commonly referred to as cerium-doped YAG (yttrium aluminum garnet). The glasses were mixed in a ratio that provided a refractive index match to the phosphor granules at the 570 nm wavelength, which is a refractive index of about 1.83.

The core-rod was fabricated by first melting the mixture of SF6 glass granules, SF57 glass granules, and phosphor granules in a nickel-foil cuvette with a glass lining. The melting was performed in a muffle furnace. The glass granules melt and the phosphor granules remained suspended in the melted mixture. The melted mixture was cooled and diced into rods having rectangular cross-sections. The sides of the diced rods were polished to minimize the possibility of microscopic air bubbles forming during the drawing process. This polishing is an important step.

The softening temperatures (T_{7.6}) of the core and cladding materials were 519° C. and 720° C., respectively. It was not necessary for the rectangular core-rod to fit exactly within the cladding-tube, as the core-rod melted completely and filled the cladding-tube when the preform was heated above the softening temperature of the cladding-tube. Accordingly, the cross-sectional shape of the cladding-tube determines the cross-sectional shape of the finished fiber waveguide. If an initial drawing produced a fiber waveguide having a cross-section that is too large, the fiber waveguide could simply be re-drawn to provide a desired cross-section. Entrance and exit facets could be polished by tightly packing a group of cut fiber waveguides in wax, within one end of a glass tube, and then grinding and polishing the end of the tube and the cut fibers therein.

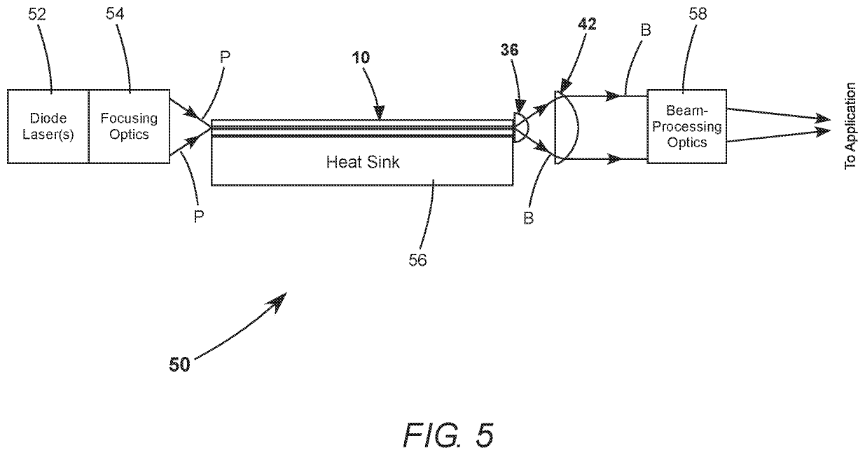

FIG. 5 schematically illustrates a preferred embodiment 50 of high-radiance wavelength-agile incoherent light-source in accordance with the present invention. Light-source 50 includes a source 52 of laser radiation for optical pumping. Pump-radiation source 52 may include a single diode-laser, a plurality of individual diode-lasers, a one-dimensional diode-laser array, or a two-dimensional diode-laser stack. The preferred choice of pump-radiation source 52 will depend on the pump and output power requirements for light-source 50.

Focusing (condensing) optics 54 are provided for focusing the pump-radiation from source 52 (depicted by peripheral rays P) into inventive fiber waveguide 10. The pump-radiation propagates along the fiber waveguide and generates broad-band incoherent radiation, as discussed above. Significant waste heat is also generated, since there is a quantum defect between the pump-radiation wavelength and the wavelength range of the broad-band radiation. This waste heat is generated along with all the broad-band radiation, both radiation that is confined and guided within the fiber waveguide and radiation that is not confined and not useful. For this reason, it is important to provide an arrangement for removing waste heat from fiber waveguide 10. In this instance, heat-removal is effected by potting the fiber waveguide into a heatsink 56.

Those skilled in the art will recognize, from the description provided above, that various arrangements known in the art for providing diode-laser end-pumping of gain-fibers or gain-rods in solid-state lasers may be used for pump-radiation source 52 and focusing optics 54. Similarly, various arrangements known for cooling gain-fibers or gain-rods in solid-state lasers may be used to cool the inventive fiber-waveguide. For example, arrangements known for cooling high-power fiber lasers. Any of these arrangements may be used without departing from the spirit and scope of the present invention.

It should be noted here that pump-radiation may be directed into the core or the cladding of the inventive fiber waveguide. Cladding-pumping can be advantageous when a pump-radiation source has insufficient brightness for focusing into just the core. Cladding-pumping can also increase the absorption length of the fiber, which reduces the amount of waste heat generated per phosphor granule.

Continuing with reference to FIG. 5, broad-band incoherent radiation (depicted by peripheral rays B) that is generated, confined, and guided within fiber waveguide 10, propagates out through end-cap 36 and is collected and collimated by lens 42. This broad-band output radiation is directed through beam-processing optics 58 before being delivered to a particular application. Beam-processing optics 58 may be configured to provide beam shaping, focusing, or wavelength filtering. An application may require a beam having a particular cross sectional shape that is not circular. By way of example, in flow cytometry, a focused beam having a rectangular cross section with a uniform intensity distribution is usually preferred.

Beam-processing optics 58 may also include interference filters, fixed or angle-tunable, to select desired wavelengths from the broad-band output radiation. Typically, the broadband radiation emitted by a cerium-doped phosphor granule has a spectral bandwidth of about 100 nm. A mixture of two or more types of phosphor granule can be used to generate radiation having an even larger total bandwidth. One or more specific wavelengths or wavelength-bands may be selected from the broad-band output radiation. For example, 640 nm, 561 nm, and 488 nm are common wavelengths used in flow cytometry, which could be selected using bandpass filters. A plurality of different wavelengths can be selected, either by filtering the output radiation from one inventive incoherent light source having a large spectral bandwidth or by filtering and combining the output radiation from multiple inventive incoherent light-sources that have different spectral bands. Wavelengths that are not commonly accessible from laser-sources may also be selected from the broad-band output radiation.

Those skilled in the art can readily design beam-shaping arrangements using commercially available ray tracing software. Catalog and customized interference filters are commercially available from several suppliers. Those skilled in the art may use any beam-shaping or spectral-selection arrangement, without departing from the spirit and scope of the present invention.

Two experimental light-sources were built using the inventive Ce³⁺:Y₃Al₅O₁₂ containing fiber waveguide described above. In each light-source, the core-diameter was about 300 μm and the cladding diameter was about 500 μm. The entrance-facet was uncoated, introducing about 9% Fresnel reflection loss for the pump diode-laser radiation. Guided broadband radiation emitted in the reverse direction was lost and there were additional smaller scattering losses. The fiber waveguide lengths in the two light-sources were 80 mm and 70 mm.

A hemispherical end-cap having a 3 mm diameter and a 3 mm effective focal length was bonded to the exit-facet using an epoxy adhesive with a refractive index of 1.7. The end-cap was a lens, Part Number 49167 available from Edmund Optics, of Barrington, N.J. This lens has a refractive index of 1.784. The aspheric lens for collection and collimation was the above-discussed Part Number A45-32HPX.1.

Diode-laser radiation for optical pumping was provided by a commercial diode-laser having a wavelength of 453 nm (blue radiation), an output power of 1 watt (W), and a spectral bandwidth of about 3 nm. The 70 mm long fiber provided a useful total output-power of 210 milliwatts (mW) of broad-band incoherent radiation. A dichroic long-pass filter having a cut-on edge at 490 nm separated 80 mW of yellow radiation from the total broad-band output radiation. The 80 mm long fiber provided a total output-power of 130 mW and 57 mW of yellow radiation.

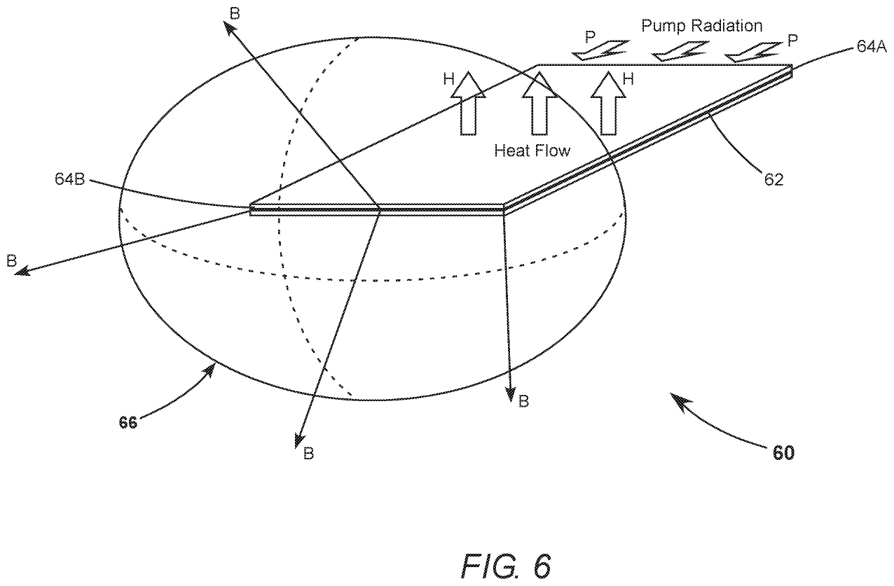

The inventive phosphor-core waveguide is not limited to the fiber waveguide described above, but may be implemented in the form of a planar or slab waveguide. An optical planar waveguide 60 in accordance with the present invention is depicted schematically in the perspective view of FIG. 6. Here, planar waveguide 60 has a phosphor-containing core 62, an entrance-facet 64A and an exit-facet 64B. An ellipsoidal end-cap 66 is bonded to exit-facet 64B. Core 62 and end-cap 66 have about the same refractive index.

Pump-radiation from one or more diode-lasers is directed into core 62 of planar waveguide 60 through entrance-facet 64A, as indicated by arrows P. A portion of the broad-band radiation emitted by energized phosphor granules in core 62 is confined within the core and guided to exit-facet 64B. Peripheral rays of broad-band radiation emerging from the exit-facet are indicated by arrows B. End-cap 66 is arranged to collect and collimate the emerging broad-band radiation. The end-cap could be spherical rather than ellipsoidal, which would simplify alignment and assembly of the planar waveguide, provided the radius of the spherical end-cap is at least three times the width of the planar waveguide.

A preferred thickness of core 62 is between about 10 μm and about 100 μm. A preferred width for planar waveguide 60 is between about 1 millimeter (mm) and about 5 mm. The length of the planar waveguide is preferably selected to be no greater than that required for all pump-radiation to be absorbed between entrance-facet 64A and exit-facet 64B. This length may be no more than a few centimeters.

Planar waveguide 60 is convenient for applications where illumination by a strip of light is required. For example, parallel capillary electrophoresis. The large surfaces of the planar waveguide are advantageous for removing waste heat. Heat-flow from one surface of the waveguide is indicated by arrows H.

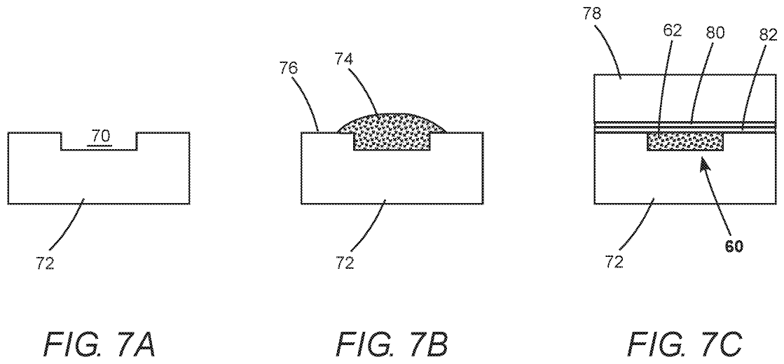

A description of one preferred construction of phosphor-containing planar waveguide 60 is set forth below with reference to FIG. 7A, FIG. 7B, and FIG. 7C. Referring to FIG. 7A, a smooth-sided channel 70 is created in a block 72 made of a low refractive-index glass, such as Gorilla® glass, available from Corning Inc. of Corning, N.Y. This glass has a refractive index of about 1.5 at a wavelength of about 570 nm. The channel can be created by wet or dry etching.

Referring next to FIG. 7B, with glass block 72 heated to a temperature of between about 700° C. and about 750° C., channel 70 is filled with a molten SF6 and SF57 mixture 74 that contains cerium-doped YAG phosphor granules. The phosphor-containing glass mixture is allowed to cool and solidify, then ground and polished flat, making it flush with surface 76 of glass block 72.

Referring finally to FIG. 7C, a polished copper heatsink 78 is coated with a reflective aluminum layer 80. The coated heatsink is then bonded to both surface 76 and the phosphor-containing glass-filled channel by an adhesive layer 82, made of a low refractive-index epoxy or silicon. Glass block 72 and adhesive layer 82 effectively provide a low refractive-index cladding about core 62 for planar waveguide 60. The planar waveguide thus formed may be end-pumped as illustrated in FIG. 6 or side-pumped through glass block 72.

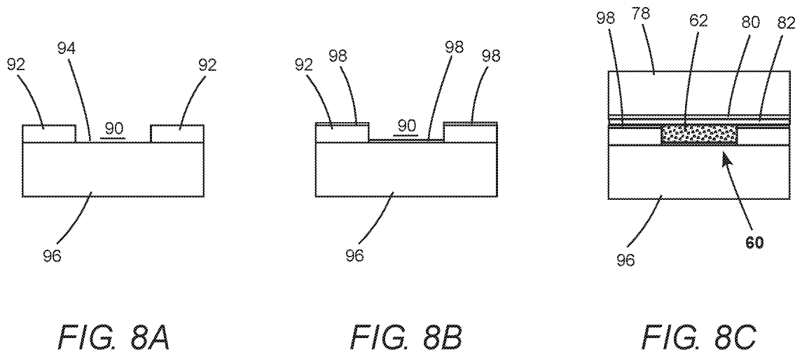

A description of another preferred construction of phosphor-containing planar waveguide 60 is set forth below with reference to FIG. 8A, FIG. 8B, and FIG. 8C. Referring to FIG. 8A, a smooth-sided channel 90 is created by bonding glass blocks 92 to surface 94 of a sapphire block 96. Glass blocks 92 are fusion bonded to surface 94 at a temperature of between about 600° C. and about 700° C. The glass blocks are made from the above-discussed Gorilla® glass.

Referring next to FIG. 8B, glass blocks 92 and exposed surface 94 of sapphire block 96 are coated with a silicon dioxide (SiO₂) layer 98. Channel 90 is then filled with a molten SF6 and SF57 mixture that contains cerium-doped YAG phosphor granules, which solidifies to form core 62, as described above. Referring finally to FIG. 8C, polished copper heatsink 78 is coated with a reflective aluminum layer 80 and then bonded to core 62 and silicon dioxide layer 98 on glass blocks 92 by adhesive layer 82, which is described above. Together, silicon dioxide layer 98 and adhesive layer 82 effectively provide a low refractive-index cladding about core 62 for planar waveguide 60.

The construction of FIGS. 8A-8C has an advantage over the construction of FIGS. 7A-7C in that planar waveguide 60 can be conduction-cooled through sapphire block 96, in addition to being conduction-cooled through heatsink 78. Sapphire has a much higher thermal conductivity than glass. However, sapphire is more expensive than glass and this construction is somewhat more complex.

In summary, embodiments of the inventive waveguide described above generate broad-band incoherent radiation by irradiating a high refractive-index glass matrix containing phosphor granules with laser radiation from one or more diode-lasers. The laser radiation, having a wavelength of less than about 550 nm, is directed into a proximal end of the waveguide. By confining a portion of the generated broad-band radiation in the waveguide, the broad-band output radiation at a distal end of the waveguide has a radiance (brightness) that is orders-of-magnitude greater than phosphorescent radiation provided by prior-art sources.

The present invention is described above in terms of a preferred embodiment and other embodiments. The invention is not limited, however, to the embodiments described and depicted herein. Rather, the invention is limited only by the claims appended hereto.

What is claimed is:

1. An optical waveguide, comprising:
a core including phosphor granules in a glass matrix, the phosphor granules and the glass matrix having about the same refractive index; and
a cladding having a refractive index less than the refractive index of the glass matrix.

2. The optical waveguide of claim 1, wherein the glass matrix has a refractive index between 1.7 and 2.0, and the cladding has a refractive index of less than 1.6.

3. The optical waveguide of claim 2, wherein the glass matrix is made of leaded heavy flint glass.

4. The optical waveguide of claim 3, wherein the leaded heavy flint glass is a mixture of SF6 and SF57 glasses.

5. The optical waveguide of claim 2, wherein the phosphor granules have rare-earth ions doped into a crystalline host material.

6. The optical waveguide of claim 3, wherein the phosphor granules are cerium-doped yttrium aluminum garnet.

7. The optical waveguide of claim 1, wherein the optical waveguide is an optical fiber waveguide.

8. Optical apparatus, comprising:
an optical waveguide having a core including phosphor granules in a glass matrix and a cladding having a refractive index less than either the phosphor granules and the glass matrix, the phosphor granules and the glass matrix of the core having about the same refractive index; and
a pump-radiation source arranged to direct pump-radiation into a proximal end of the optical waveguide, the pump-radiation propagating along the waveguide, the pump-radiation causing the phosphor granules to emit broad-band incoherent radiation, a portion of the broad-band incoherent radiation guided by the waveguide to a distal end of the optical waveguide.

9. The apparatus of claim 8, wherein the glass matrix has a refractive index between 1.7 and 2.0, and the cladding has a refractive index of less than 1.6.

10. The apparatus of claim 9, wherein the glass matrix is made of leaded heavy flint glass.

11. The optical waveguide of claim 10, wherein the leaded heavy flint glass is a mixture of SF6 and SF57 glasses.

12. The apparatus of claim 9, wherein the phosphor granules have rare-earth ions doped into a crystalline host material.

13. The apparatus of claim 12, wherein the phosphor granules are cerium-doped yttrium aluminum garnet.

14. The apparatus of claim 8, wherein the optical waveguide is an optical fiber waveguide.

15. The apparatus of claim 14, wherein the core has a diameter between 10 micrometers and 500 micrometers, and the cladding has a diameter between 100 micrometers and 1000 micrometers.

16. The apparatus of claim 14, further including a hemispherical end-cap attached to the distal end of the optical fiber waveguide, the end-cap having about the same refractive index as the core.

17. The apparatus of claim 8, wherein the pump-radiation has a wavelength less than 550 nanometers.

18. The apparatus of claim 8, wherein the pump-radiation source is a diode-laser.

19. The apparatus of claim 8, further including a dichroic coating on the proximal end of the optical waveguide, the dichroic coating being transparent to the pump-radiation and reflective for the broad-band incoherent radiation.

20. A light-source, comprising:
a fiber waveguide having a proximal end and a distal end, the fiber waveguide including a core having phosphor granules in a glass matrix and a cladding, the core having a higher refractive index than the cladding, and with the phosphor granules and the glass matrix having about the same refractive index;
a pump-radiation source arranged to direct pump-radiation into the proximal end of the fiber waveguide, the pump-radiation propagating along the fiber waveguide, the pump-radiation causing the phosphor granules to emit broad-band incoherent radiation, a portion of the broad-band incoherent radiation guided by the waveguide to a distal end of the optical waveguide;
a hemispherical end-cap attached to the distal end of the optical fiber waveguide, the end-cap having about the same refractive index as the core;
a lens arranged to collect broad-band incoherent radiation transmitted through the end-cap; and
spectral-selection optics, the lens directing the broad-band incoherent radiation into the spectral-selection optics.

21. The light-source of claim 20, wherein the core has a diameter between 10 micrometers and 500 micrometers, and the cladding has a diameter between 100 micrometers and 1000 micrometers.

22. The light-source of claim 20, wherein the hemispherical end-cap has a diameter greater than that of the fiber waveguide.

23. The light-source of claim 20, wherein the lens is an aspheric lens.

24. The light-source of claim 20, wherein the pump-radiation source is a diode-laser and the pump-radiation has a wavelength less than 550 nanometers.

25. The light-source of claim 20, wherein the broad-band incoherent radiation has bandwidth of about 100 nm.
